(19) United States
(12) Patent Application Publication
(10) Pub. No.: US 2011/0193765 A1
(43) Pub. Date: Aug. 11, 2011

(54) ANTENNA ASSEMBLY

(76) Inventor: Cheng-Si WANG, Hua Tan Hsiang (TW)

(21) Appl. No.: 12/703,180

(22) Filed: Feb. 9, 2010

(51) Int. Cl. H01Q 1/10; F16M 11/04; H01Q 3/02; H01Q 1/12

(52) U.S. Cl. 343/882; 248/125.1; 343/883

(57) ABSTRACT

An antenna assembly has an antenna and a bracket. The bracket is connected with the antenna and has a hanger, a telescopic strut and an antenna stand. The telescopic strut is mounted securely on the hanger and has a base tube and a moving rod mounted slidably and rotatably in the base tube. The antenna stand is mounted securely on the moving rod and is detachably connected with the antenna. Because the moving rod is capable of being raised, lowered and rotated relative to the hanger, it is very convenient and easy to position the antenna for adjustment and improved receipt of signals.

### BACKGROUND OF THE INVENTION

1. Field of the Invention

The present invention relates to an antenna assembly, and more particularly to an antenna assembly which is easily attached to a monitor and is conveniently positioned for adjustment and improved receipt of signals.

2. Description of Related Art

A conventional antenna assembly comprises an antenna and an antenna bracket. The antenna bracket has a bottom and a top on which the antenna is detachably mounted. The bottom of the antenna bracket is mounted on a flat surface, such as a desk.

However, a flat surface is always needed for the placement of the antenna bracket, so users have to find a flat surface to mount the antenna bracket and this is not convenient. Moreover, the antenna bracket is awkward and bulky because the antenna bracket occupies a space on a flat surface, such as a desk and cannot be mounted on a monitor. Besides, the antenna is not capable of being raised or lowered to clearly receive signals.

To overcome the shortcomings, the present invention tends to provide an antenna assembly to obviate the aforementioned problems.

### SUMMARY OF THE INVENTION

The main objective of the invention is to provide an antenna assembly which is easily attached to a monitor and is conveniently positioned for adjustment and improved receipt of signals.

An antenna assembly has an antenna and a bracket. The bracket is connected with the antenna and has a hanger, a telescopic strut and an antenna stand. The telescopic strut is mounted securely on the hanger and has a base tube and a moving rod mounted slidably and rotatably in the base tube. The antenna stand is mounted securely on the moving rod and is detachably connected with the antenna. Because the moving rod is capable of being raised, lowered and rotated relative to the hanger, it is very convenient and easy to position the antenna for adjustment and improved receipt of signals.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an antenna assembly in accordance with the present invention;

FIG. 2 is a partially exploded perspective view of the antenna assembly in FIG. 1;

FIG. 3 is an enlarged side view in partial section of the antenna assembly in FIG. 1;

FIG. 4 is an enlarged side view of the antenna assembly in FIG. 1, showing the base mount and the base tube; and

FIG. 5 is an operational perspective view of the antenna assembly in FIG. 1 mounted on a notebook.

### DETAILED DESCRIPTION OF PREFERRED EMBODIMENT

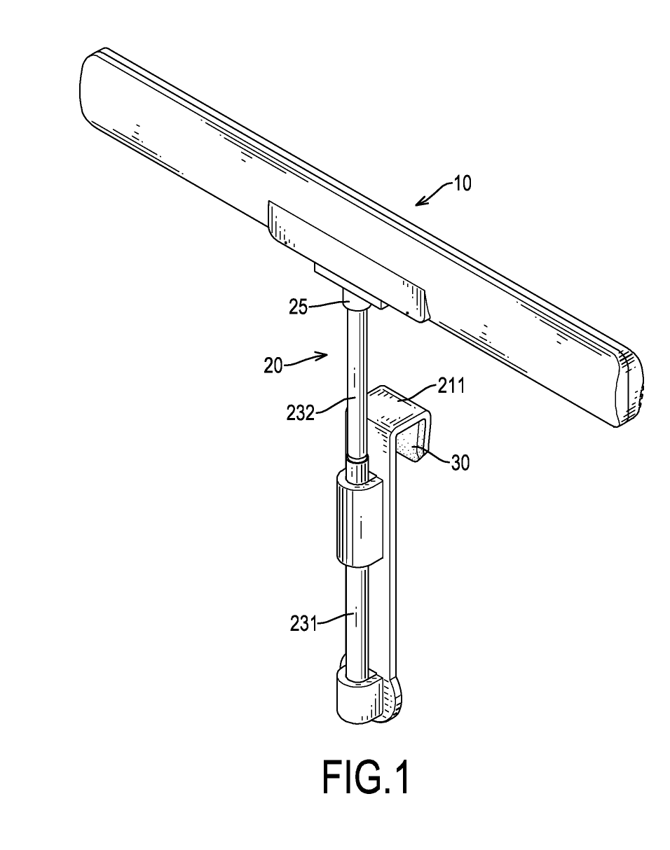

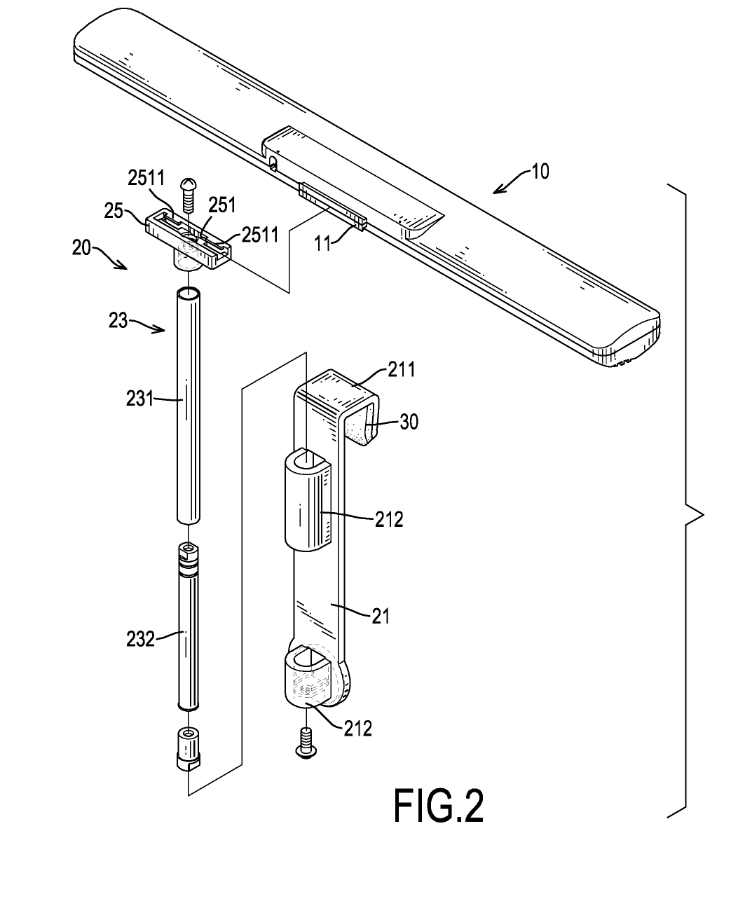

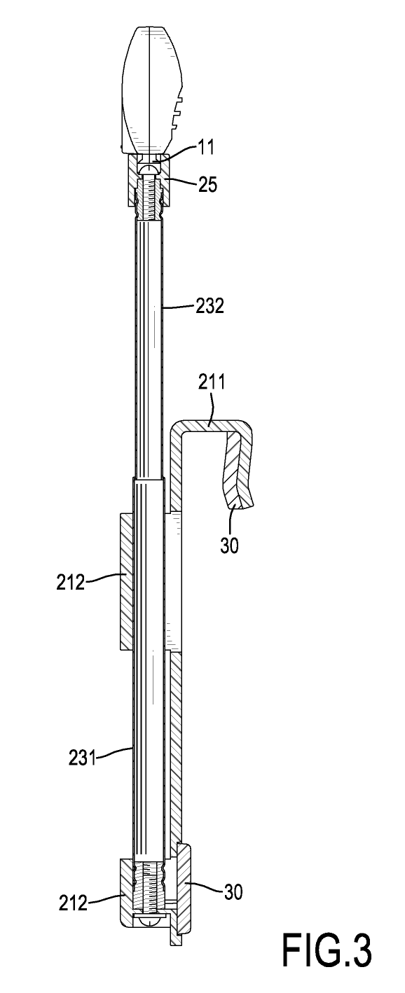

With reference to FIGS. 1 to 3, an antenna assembly in accordance with the present invention comprises an antenna (10), a bracket (20) and two pads (30).

The antenna (10) is horizontal and has a central segment and a rib (11). The rib (11) protrudes from the central segment of the antenna (10). Preferably, the rib (11) is dovetailed in cross section.

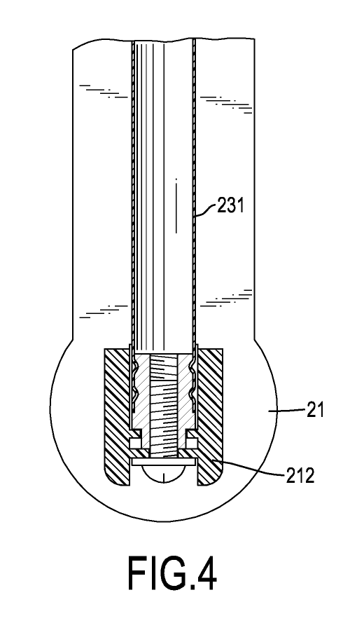

With further reference to FIG. 4, the bracket (20) is detachably connected with the antenna (10) and has a hanger (21), a telescopic strut (23) and an antenna stand (25).

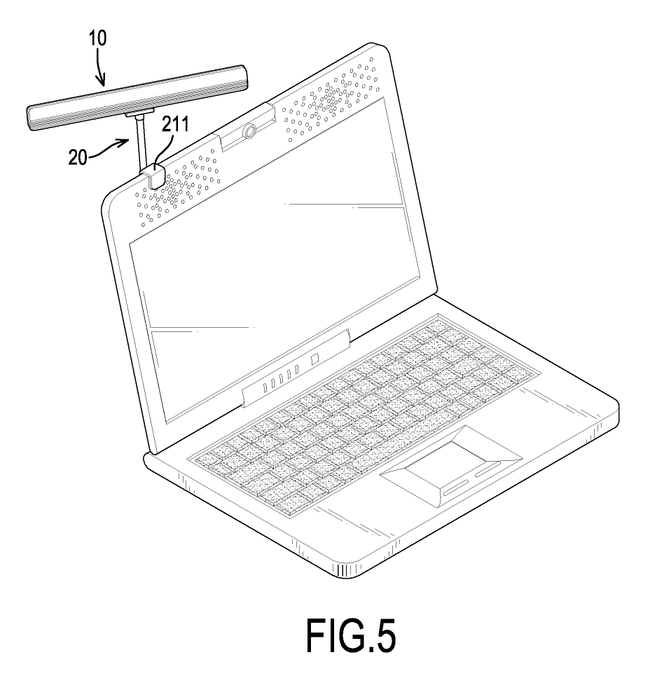

The hanger (21) is elongated and has a top, a bottom, a hook (211), an outer side, an inner side and two base mounts (212). The hook (211) is formed on the top of the hanger (21) and has an inverted L-shaped cross section and an inner side. The inner side of the hook (211) faces the inner side of the hanger (21). The hook (211) can be attached to a monitor, maybe of a notebook as shown in FIG. 5. The outer side of the hanger (21) is opposite to the hook (211). The base mounts (212) are tubular, are separately formed on the outer side of the hanger (21) and are respectively adjacent to the top and the bottom of the hanger (21).

The telescopic strut (23) is mounted securely on the hanger (21) and has a base tube (231), a moving rod (232) and a stand end. The base tube (231) is mounted securely in the base mounts (212). The moving rod (232) is mounted slidably and rotatably in the base tube (231). The stand end is formed on one end of the moving rod (232) and is adjacent to the hook (211). Alternatively, the moving rod (232) may be mounted securely on the base mounts (212), and the stand end is formed on one end of the base tube (231). As long as the moving rod (232) is capable of sliding relative to the base tube (231), the present invention is not limited by methods of mounting the telescopic strut (23) on the hanger (21).

The antenna stand (25) is mounted securely on the stand end of the telescopic strut (23), is mounted above the hook (211) and has a top and a recess (251). The recess (251) is defined in the top of the antenna stand (25), is detachably connected with the rib (11) and has an open end which allows the rib (11) to slide into the recess (251).

Preferably, the recess (251) has an inner side and two tabs (2511). The tabs (2511) protrude inward from the inner side of the recess (251). Alternatively, the recess (251) may be dovetailed in cross section. As long as the recess (251) is capable of detachably connecting with the rib (11), the present invention is not limited by methods of connecting of the recess (251) and the rib (11).

One of the pads (30) is mounted securely on the inner side of the hook (211), and the other pad (30) is mounted securely on the bottom at the inner side of the hanger (21).

With further reference to FIG. 5, when the antenna assembly in accordance with the present invention is in use, the hook (211) is attached to a monitor of a notebook. The monitor of the notebook has two opposite sides. The pads (30) respectively abut the sides of the monitor. Consequently, the bracket (20) is capable of being secured to the monitor. To adjust the antenna (10) for improved receipt of signals, the moving rod (232) is raised or lowered, is rotated relative to the base tube (231) and is positioned by friction between the moving rod (232) and the base tube (231). Accordingly, the antenna (10) can be adjusted to a desired position and angle for optimally receipt of signals.

From the above description, it is noted that the present invention has the following advantages:

1. Easy adjustment and improved receipt of signals:

Because the moving rod (232) is capable of being raised, lowered, and rotated relative to the hanger (21) and positioned by friction, it is very convenient and easy to position the antenna (10) for adjustment and improved receipt of signals.

2. No awkwardness and bulkiness:

Because the hook (211) is capable of being attached to any monitor, a flat surface is not needed for the placement of the antenna assembly.

3. No damage of the monitor:

The pads (30) prevent the hanger (21) from directly touching the monitor and this can avoid scratching the surface of the monitor.

4. Prevention of interfering in receiving signals:

Because the moving rod (232) is capable of being raised relative to the hanger (21) and the antenna (10) can be moved away from the monitor, the antenna (10) can receive signals without interference by the monitor.

Even though numerous characteristics and advantages of the present invention have been apparatus forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna assembly comprising:
an antenna having
an outer surface;
a rib protruding from the outer surface of the antenna; and
a bracket detachably connected with the antenna and having
a hanger having
an inner side;
an outer side being opposite to the inner side; and
a hook protruding from the inner side of the hanger and having an inverted L-shaped cross section; and
a telescopic strut mounted securely on the outer side of the hanger and having
a base tube mounted securely on the outer side of the hanger;
a moving rod slidably and rotatably mounted in the base tube; and
a stand end formed on one end of the moving rod; and
an antenna stand mounted securely on the stand end of the telescopic strut, mounted above the hook and having
a top; and
a recess defined in the top of the antenna stand, detachably connected with the rib and having
an open end which allows the rib to slide into the recess;
an inner side; and
two tabs protruding inward from the inner side of the recess.

2. The antenna assembly as claimed in claim 1, wherein
the hanger has a top and a bottom;
the hook is formed on the top of the hanger and has an inner side facing the inner side of the hanger;
the antenna assembly further has two pads respectively mounted securely on the inner side of the hook and the bottom at the inner side of the hanger.
